(19) United States
(12) Patent Application Publication
(10) Pub. No.: US 2002/0153728 A1
(43) Pub. Date: Oct. 24, 2002

(54) Wind turbine

(76) Inventor: Wilhelm Groppel, Melle (DE)

Correspondence Address: HENRY M FEIEREISEN, 350 FIFTH AVENUE, SUITE 3220, NEW YORK, NY, 10118, US

(21) Appl. No.: 10/128,859

(22) Filed: Apr. 23, 2002

(30) Foreign Application Priority Data
Apr. 24, 2001 (DE) 101 20 181.8

(51) Int. Cl. F03D 9/00; H02P 9/04

(52) U.S. Cl. 290/44

(57) ABSTRACT

The invention relates to a wind turbine that extends about a mast on a bearing ring, and comprises two rotors furnished with rotor blades; wherein the rotors are rotatably disposed on the bearing ring and on either side of the mast and a wind deflector plate that extends partially around the mast and is rotatably disposed on the bearing ring, wherein the wind deflector plate is oriented so that the wind blowing towards the mast is diverted towards the rotor blades.

### CROSS-REFERENCES TO RELATED APPLICATIONS

This application claims the priority of German Patent Application Serial No. 101 20 181.8, filed Apr. 24, 2001, the subject matter of which is incorporated herein by reference

### BACKGROUND OF THE INVENTION

The invention relates generally to wind turbines and in particular to a wind turbine that can also be used in conjunction with a wind driven power plant for generating electrical energy.

As the use and exploitation of alternative energy sources is growing, there is also an increased need for suitable locations for such installations or devices. Wind driven power plants can only be operated on sites close to the coast or in exposed elevated locations if economical operation is to be achieved. However, most of locations of this type are already occupied by wind driven power plants.

Due to the size of these wind driven power plants and the space they require, it is often not possible to install additional installations of such wind driven power plants in the same locations. Accordingly, the lack of space represents one of the most intractable obstacles to their erection.

A further significant drawback of wind driven power plants that have large rotors is the shadow they cast by their rotor blades. As they rotate, the rotor blades cast a shadow. The shadow is cast whenever the rays of the sun are blocked because of the position of the rotor. As they rotate, the rotor blades cast a shadow that returns within fixed intervals. This effect of the shadow limits the areas in which it is possible to install further wind engines. In populated regions, the shadow is becoming the object of more frequent complaints by the inhabitants. This often causes physical and psychological problems, which are attributable to the shadow of the rotors.

It would therefore be desirable and advantageous to provide an improved wind driven power plant, which obviates the drawbacks of these shortcomings and to extend existing wind driven power plants to provide them with means for a better utilisation of wind energy.

### SUMMARY OF THE INVENTION

According to one aspect of the invention an auxiliary wind turbine is provided for use with a wind driven power plant and designed with means to optimally utilize the wind driving the wind driven power plant.

According to another aspect of the invention, the auxiliary wind turbine comprises a bearing ring, which is designed to orient the wind turbine according to the invention so that its rotors are optimally positioned with respect to the direction of the wind.

In one embodiment of the wind turbine according to the invention, the wind turbine is furnished with at least two rotors, which are equipped with rotor blades. In a preferred embodiment, the rotor blades are paddle shaped. The rotor blades may also have the form of propeller blades, and in this case the rotor axis must be rotated through ninety degrees.

The rotors of the wind turbine according to the invention are positioned on either side of the mast of the wind driven power plant, although the arrangement of the rotors does not have to be symmetrical relative to the mast. The axes of the rotors may also be positioned somewhat behind or in front of the mast.

The rotors are disposed on the bearing ring, which extends around the mast. Thus, the rotors can revolve through 360 degrees about the axis of the mast. This ensures that the rotors are positioned against the direction of the wind. A wind deflector plate is designed to ensure that the wind strikes the rotors of the auxiliary wind turbine in an optimal way. The wind deflector plate is positioned so it is in front of the mast, so that the wind blowing towards the mast of the wind driven power plant can be diverted around the body of the mast. The wind deflector plate extends partially around the mast of the wind driven power plant and is preferably arranged on bearing ring so that a rotational motion can be realized. Depending on the orientation of the rotors, a different part of the mast is covered. The wind deflector plate is configured in such a manner so as to ensure that the wind blowing against the rotors is distributed as equally as possible. Thus, the wind deflector plate may be acutely angled or rounded. In a possible configuration, the wind deflector plate is acutely angled at its apex in order to divide the flow of air striking the mast. In any event, the wind deflector plate should always be shaped such that the air blowing towards the mast is diverted towards the rotor blades.

In an advantageously designed embodiment, the rotors are disposed in a shroud, which is furnished with inlet and outlet openings for the air. In this case, the size of the air outlet openings should be smaller than that of the air inlet openings in order to create a wake effect. This wake effect enhances the efficiency of the wind turbine arrangement due to he wake causing the air inside the shroud to flow more quickly to thereby cause the rotors to turn faster.

A control device is provided to control the volume of air that flows through the shroud. The control device includes an airflow governor preferably in the form of a panel, which is arranged between each rotor and the air inlet opening. The airflow governor is moved into the air flow by a drive unit. The air flow governor is preferably configured as a segment of a circle, which partially encircles the rotor.

In a first embodiment, the rotor axis is disposed parallel to the vertical mast of the wind driven power plant, and the rotor of the wind turbine is configured in the form of a paddle wheel. However, it is also envisioned that the rotor axis be arranged perpendicularly to the vertical mast, wherein the rotor is then configured in the form of a propeller. In that case, the airflow governor would also be shaped differently. The air flows governor then preferably is configured in the form of a straight panel, which moves in front of the rotor blades. However, it is also possible to arrange the rotor blades so they rotate and so that the amount of wind resistance offered by the rotor blades may be determined by adjusting the pitch of the blades.

The orientation of the rotors on the bearing ring is realized preferably by a carrier, which is connected to the generator of the wind driven power plant. For example, the carrier may be configured as a ladder extending from the generator housing of the existing wind driven power plant to the bearing ring as also seen on FIG. 3. This arrangement serves to prevent a possible collision between the rotors that are rotatably mounted on the bearing ring and the generator housing that is rotatably mounted on the wind driven power plant. The wind turbine 10 is provided with its own drive—not shown here—when a carrier is not utilized.

### BRIEF DESCRIPTION OF THE DRAWING

Other features and advantages of the present invention will be more readily apparent upon reading the following description of currently preferred exemplary embodiments of the invention with reference to the accompanying drawing, in which:

FIG. 1 shows the side view of a known wind driven power plant in combination with a wind turbine according to the invention, which is arranged below the generator of the wind driven power plant and which is connected with the known wind driven power plant by a carrier.

FIG. 2 shows a front view of the wind turbine of FIG. 1, wherein the air inlet openings can be seen in the shroud of the wind turbine according to the invention;

FIG. 3 shows a schematic plan view of the wind turbine of FIG. 1, wherein the generator and the rotors are shown to be mechanically connected in the form of a ladder;

FIG. 4 shows a detailed plan view of the wind turbine according to the invention, with a bearing ring arranged about a mast, and equipped with rotors that are arranged inside a shroud, wherein the shroud has inlet and outlet apertures for the air flow.

FIG. 5 shows a schematic plan view of the wind turbine without the mechanical connection between the generator and the rotors.

Numerous variants and improvements may be applied to the described embodiments within the scope of the present invention. One possible configuration is described with reference to the accompanying figures.

### DETAILED DESCRIPTION OF PREFERRED EMBODIMENTS

Throughout all the Figures, same or corresponding control units are generally indicated by same reference numerals.

Turning now to the drawings, and in particular to FIG. 1, there is shown a wind turbine 10 according to the invention, which is secured to wind driven power plant 24 known in the prior art. The attachment of the wind turbine to the known wind driven power plant is realized via a bearing ring 19, which extends around mast 22 of wind driven power plant 24. The bearing ring 19 is preferably furnished with securing control units in the form of stays, which extend from the interior of the bearing ring 19 to the exterior of the mast 22. The stays may be of variable length, so that the device according to the invention may be adapted to many different mast types having various profiles.

The bearing ring 19 supports two rotors 10, which are furnished with a plurality of rotor blades 11. The use of a bearing ring 19 ensures that the wind turbine 10 according to the invention is directed optimally into the wind. The orientation of wind turbine 10 is assured by a carrier 20 which is connected to generator housing 25, which is movably disposed at the wind driven power plant 24. The carrier may be configured in the shape of a ladder, which can be utilized for maintenance to be performed on wind turbine 10 according to the invention. A flap may be provided to allow personnel to exit generator housing 25 of wind driven power plant 24 and allowing access to the ladder.

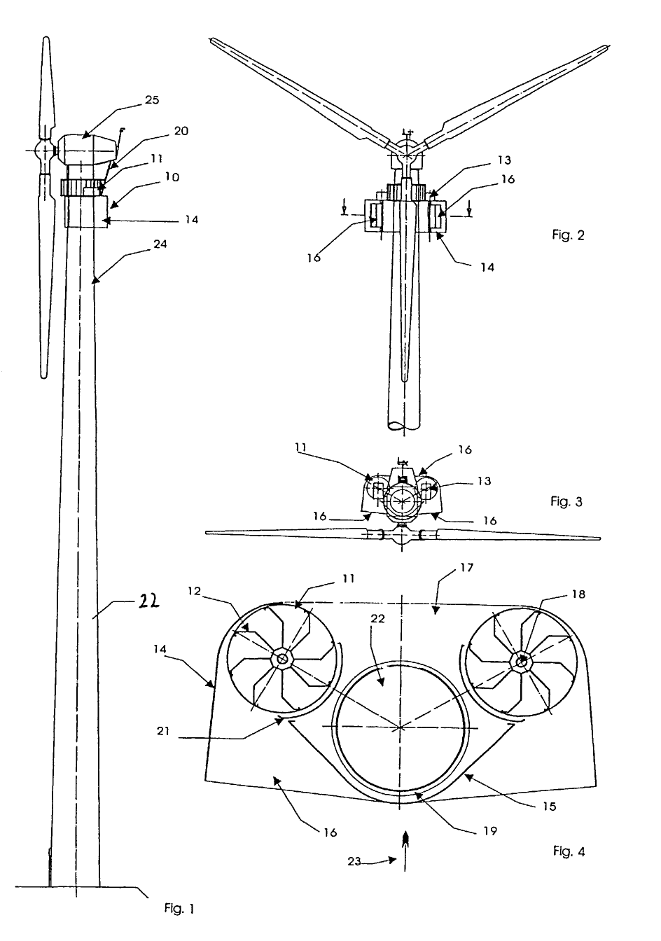

FIG. 2 shows that wind turbine 10 has a shroud 14 that is furnished with inlet openings 16 and an outlet openings 17 for air. A wind deflector plate 15 is disposed between air inlet openings 16, which extend to the right and left of the mast, dividing the air flow in such a manner that the wind strikes both rotors, which are positioned behind air inlet openings 16, in equal proportions.

FIG. 4 shows a more detailed illustration of wind deflector plate 15. One possible embodiment of wind deflector plate 15 includes that it has a cross section conforming to the shape of the mast. In another possible embodiment, the wind deflector plate 15 is acutely angled at its apex. The apex is normally located in the radial center of the mast. In a further possible embodiment the apex of the wind deflector plate runs into a point. The wind deflector plate is then configured with a profile that corresponds to a triangle.

FIG. 4 further shows that rotors 11 are disposed on rotor axes 18. The rotor axes 18 in turn are connected to bearing ring 19. Rotors 11 have rotor blades 12, which are preferably furnished with recesses—not shown—to optimize the draft. In a further embodiment, rotor blades 12 do not extend as far as rotor axis 18. Instead, the larger part of rotor blade 12 is located in the peripheral area of rotor 11.

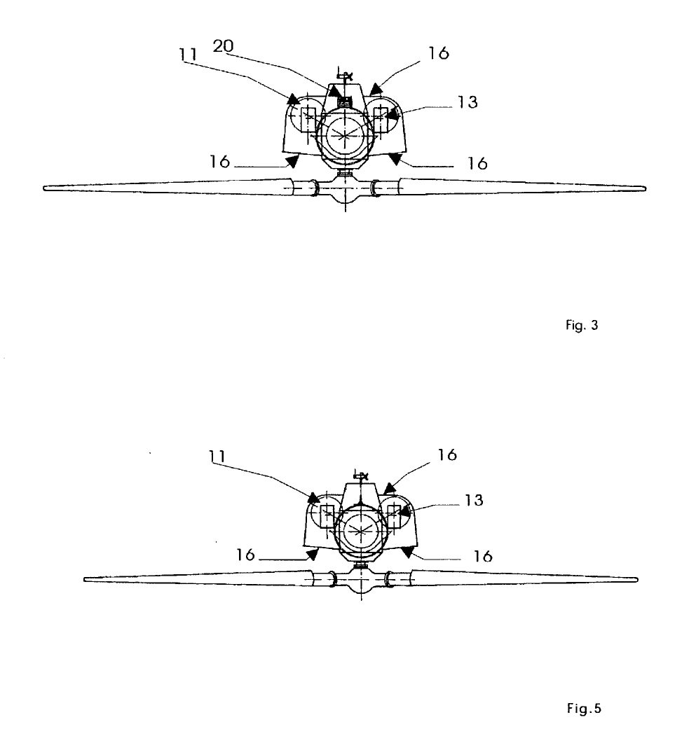

FIG. 3 shows generators 13, which are connected to rotor axes 18. The generators generate electrical power. This electrical power may be converted for use in the public energy network by the transformers, which are part of wind driven power plant 24. Further shown in FIG. 3 is the carrier connecting the generator of the wind driven power plant to the wind turbine. FIG. 5 shows the wind turbine without a carrier.

In order to control the volume of air that flows through shroud 14, airflow governor 21 can be moved in front of rotors 11. Airflow governor 21 shown in FIG. 3 has a profile that has a cross section configured in the shape of the segment of a circle. This configuration permits it to be moved around the circular rotor. Airflow governor 21 is preferably moved by a drive unit (not shown). This drive unit is controlled by the speed of the wind. In a further configuration (not shown) the drive unit may also determine the position, respectively the pitch of rotor blades 12.

In accordance with the invention, the wind turbine should be aligned as optimally as possible against the wind direction 23. An optimum alignment is realized when the air inlet openings are facing directly into the wind 23. In this position, the air mass is directed optimally towards the rotor blades by means of wind deflector plate 15.

While the invention has been illustrated and described as embodied in a wind turbine for a wind driven power plant, it is not intended to be limited to the details shown, since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A wind turbine, comprising:
a rotor assembly having two rotors which are rotatably mounted on a bearing ring on opposite sides of a mast and provided with rotor blades; and an air deflector plate extending about predetermined areas of the mast and rotatably mounted on the bearing ring, said air deflector plate being configured and positioned to direct incoming air towards the rotor blades.

2. The wind turbine of claim 1, and further comprising a shroud around the rotor assembly and having inlet means for entry of the incoming air and outlet means for exit of air.

3. The wind turbine of claim 2, wherein the outlet means is defined by an opening area which is smaller than an opening area of the inlet means to thereby realize a wake effect.

4. The wind turbine of claim 2, and further comprising a control device, disposed in the shroud, for limiting a volume of the incoming air that flows through the shroud and is directed toward the rotor assembly.

5. The wind turbine of claim 4, wherein the control device includes an air flow governor for each said rotor of the rotor assembly, said air flow governor configured in the form of a panel and disposed between the rotor and the inlet means.

6. The wind turbine of claim 5, wherein the panel is a metal sheet.

7. The wind turbine of claim 5; wherein the airflow governor has a curved configuration to partially encircle the rotor.

8. The wind turbine of claim 5, wherein the control device includes a drive for operating the air flow governor.

9. The wind turbine of claim 1, wherein each of the rotors rotates about a rotation axis in parallel relationship to a vertical extension of the mast and is configured in the form of a paddle wheel.

10. The wind turbine of claim 1, wherein each of the rotors rotates about a rotation axis oriented perpendicular to a vertical extension of the mast and is configured in the form of a propeller.

11. The wind turbine of claim 1, and further comprising a carrier for connecting the rotor assembly to a rotatable generator housing of the wind turbine.

12. The wind turbine of claim 1, wherein the air deflector plate has a pointed apex to divide the flow of incoming air into partial streams.

13. The wind turbine of claim 1, wherein the bearing ring includes a drive for orientation of the bearing ring.
